(19) United States
(12) Patent Application Publication
(10) Pub. No.: US 2022/0296933 A1
(43) Pub. Date: Sep. 22, 2022

(54) POWERED AIR PURIFYING RESPIRATOR AND METHOD OF OPERATION

(71) Applicant: MDR ARCOM LLC, Richardson, TX (US)

(72) Inventors: Robert Godwin, Chula Vista, CA (US); Jason Gao, Shanghai (CN); David Chen, Hubei Province (CN); Kenneth Hoffman, Casa Grande, AZ (US); Fred Brown, Middle Grove, NY (US)

(21) Appl. No.: 17/212,054

(22) Filed: Mar. 25, 2021

(30) Foreign Application Priority Data
Mar. 22, 2021 (CN) 202110304784.7

(51) Int. Cl. A62B 7/10; A62B 18/00; A62B 18/08; A62B 9/00; A62B 23/02; A62B 9/02

(52) U.S. Cl. CPC A62B 7/10; A62B 18/006; A62B 18/08; A62B 9/006; A62B 23/02; A62B 9/02

(57) ABSTRACT

A powered air purifying respirator and method of operating the same. The powered air purifying respirator comprises a fluid moving device. The fluid moving device comprises an outlet, an airflow sensor retaining member located proximate to the outlet, and an airflow sensor engaged with the airflow sensor retaining member.

### FIELD

The present teachings generally relate to a powered air purifying respirator and method of operating the same.

### BACKGROUND

Powered air purifying respirators are employed to protect the health and safety of workers in various occupational settings such as construction sites, manufacturing shops, biological laboratories, chemical laboratories, nuclear sites, and the like. Powered air purifying respirators draw surrounding air through filters to provide workers with air that is substantially free of harmful chemicals, pathogens, and/or particulates.

Filters are typically provided in various configurations and with various substrates, each tailored to a specific occupational setting. For example, a filter with a substrate that filters out pathogens may be employed in a biological laboratory. Filters generally include substrates that capture only a certain sub-section of commonly encountered chemicals, pathogens, and/or particulates. Accordingly, consumers may choose filters tailored to their particular use circumstances while avoiding the expense of filters that neutralize chemicals, pathogens, and/or particulates that are not typically encountered by those consumers.

The properties of different substrates, such as pore size, thickness, and material, direct how much air resistance the substrates impose on air passing through the filter. Due to varying air resistance between different types of filters, different powered air purifying respirator settings should be adjusted to provide users with a suitable volume of air to avoid health risks. For example, as air resistance increases, blower speed should increase generally proportionally to move a suitable volume of air through the filter and provide the same to a worker. Manual adjustment of settings presents the challenge of human error. A user may forget to adjust settings based upon the particular filter they are employing, or the user may adjust settings incorrectly. Air resistance can also change during the service life of the filter, further complicating the manual adjustment of settings.

The properties of substrates used for certain applications can also direct the physical configurations of the air purifying respirator. Conventional air purifying respirators are configured to employ either one, two, or three separate filters simultaneously. In this manner, a suitable volume of air supply can be provided to a user whether a higher or lower air resistance substrate is employed. For example, one filter may provide a suitable volume of air supply for a substrate with low air resistance while three filters may provide a suitable volume of air supply for three substrates with high air resistance. Powered air purifying respirators cannot be used with one or more open inlets that are not occupied by a filter or other suitable member for either filtering or blocking airflow because chemicals, pathogens, and/or particulates may enter the inlet and be inhaled by a user. Conventional powered air purifying respirators are typically provided as different models suited for different occupational settings. As a result, the complexity of determining which type of powered air purifying respirator is suitable for a particular use circumstance and the expense of purchasing multiple different models to suit consumers that may encounter different use circumstances presents a challenge.

It would be desirable to provide a powered air purifying respirator that can be used for a variety of different use circumstances. It would be desirable to provide a powered air purifying respirator that can be used with a variety of different types of filters. It would be desirable to provide a powered air purifying respirator that can autonomously adjust its settings to suit a variety of different types of filters. It would be desirable to provide a powered air purifying respirator that prevents air from flowing through inlets that are not occupied by a filter. It would be desirable to provide a powered air purifying respirator that can adapt to various different use circumstances without the need for users to continuously monitor and/or manually adjust the settings of the powered air purifying respirator.

### SUMMARY

The present disclosure relates to a powered air purifying respirator, which may address at least some of the needs identified above. The powered air purifying respirator may comprise a fluid moving device. The fluid moving device may comprise an outlet, an airflow sensor retaining member located proximate to the outlet, and an airflow sensor engaged with the airflow sensor retaining member.

The present disclosure relates to a powered air purifying respirator, which may address at least some of the needs identified above. The powered air purifying respirator may comprise one or more valve assemblies, each of the one or more valve assemblies adapted to engage a filter. The one or more valve assemblies may allow air to flow therethrough when the filter is engaged with the one or more valve assemblies. The one or more valve assemblies prevent the air from flowing therethrough when the one or more valve assemblies are free of engagement with the filter.

The present disclosure relates to a method of operating a powered air purifying respirator, which may address at least some of the needs identified above. The method may comprise receiving, by the powered air purifying respirator, a first filter at a first time; sensing, by an airflow sensor, an airflow; directing, by a controller in communication with the airflow sensor, a blower speed based upon the airflow; receiving, by the powered air purifying respirator, a second filter at a second time; and repeating the sensing step and the directing step for the second filter. The first filter and the second filter may be characterized by a different rating according to BS EN 14387:2004+A1:2008.

### BRIEF DESCRIPTION OF THE DRAWINGS

FIG. 1 illustrates a perspective view of respirator assembly worn by a user.

FIG. 2 is perspective view of a respirator assembly.

FIG. 3 is an exploded view of a powered air purifying respirator.

FIG. 4 is a perspective view of a valve assembly.

FIG. 5 is an exploded view of a valve assembly.

FIG. 6 is a cross-sectional view of the valve assembly illustrated in FIG. 4, along line A-A.

FIG. 7 is a perspective view of a valve assembly.

FIG. 8 is a perspective view of a fluid moving device.

FIG. 9 is a cross-sectional view of the fluid moving device illustrated in FIG. 8, along line B-B.

FIG. 10 a perspective view of a powered air purifying respirator.

FIG. 11 illustrates a flow chart of the method according to the present disclosure.

### DETAILED DESCRIPTION

The present teachings meet one or more of the above needs by the improved powered air purifying respirator and method of operating the same described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present disclosure provides for a respirator assembly. The respirator assembly may function to be worn by a user; provide air to a user; neutralize chemicals, pathogens, particulates, or any combination thereof; or any combination thereof. The respirator assembly may be employed in a variety of occupational settings. The occupational settings may include construction sites, demolition sites, manufacturing shops, disaster clean-up zones, biological laboratories, chemical laboratories, hospitals, quarantine zones, nuclear sites, the like, or any combination thereof. The respirator assembly may be employed by one or more workers (i.e., users) working in the occupational setting. The respirator assembly may be configured to suit a particular occupational setting and/or use circumstance. The respirator assembly may be configured by adding or removing filters, sealing or un-sealing inlets, adjusting the speed of a fluid moving device, or any combination thereof. The respirator assembly may comprise one or more straps, powered air purifying respirators, or both.

The respirator assembly may comprise one or more straps. The strap may function to retain a powered air purifying respirator on a body of a user. The strap may be worn around a waist, belly, or chest of a user, or any combination thereof. The strap may locate a powered air purifying respirator on a body of a user where the user can readily view and/or interact with the powered air purifying respirator. The strap may include a belt, harness, the like, or any combination thereof. A powered air purifying respirator may be coupled to the strap. A back plate of a powered air purifying respirator may be coupled to the strap. A powered air purifying respirator may be removable from the strap.

The respirator assembly may comprise one or more powered air purifying respirators (PAPR). The powered air purifying respirator may function to provide air to a user; neutralize chemicals, pathogens, particulates, or any combination thereof or both. Chemicals, pathogens, particulates, or any combination thereof may be referred to herein as contaminants. The powered air purifying respirator may draw surrounding air through filters to neutralize contaminants before delivering the air to a user. As referred to herein, neutralize may mean trapping, adsorbing, absorbing, or chemically altering contaminants, or any combination thereof. The powered air purifying respirator may cooperate with one or more hoses, half facepieces, full facepieces, hoods, helmets, the like, or any combination thereof. Half facepieces, full facepieces, hoods, helmets, the like, or any combination thereof may be referred to herein as headpieces. The powered air purifying respirator may draw air through a filter and deliver the air to a hose. The hose may direct air to a headpiece. The headpiece may be worn by a user. The user may breathe air that has been purified by the filter. As referred to herein, purified may refer to air that has passed through a filter; is substantially or completely free of contaminants; or both. Substantially free of contaminants may mean contaminants in an amount of about 5% or less, 2% or less, 1% or less, 0.1% or less, or even 0.01% or less, by volume. The powered air purifying respirator may include one or more sides. As referred to herein, a back side may be oriented toward a user, a front side may be oriented away from a user, a top side may be oriented toward a head of a user, a bottom side may be oriented toward the feet of a user, a left side may be oriented to the left of a user, and a right side may be oriented toward the right of a user, while the user is wearing the powered air purifying respirator. The powered air purifying respirator may comprise one or more PAPR housings, back plates, covers, displays buttons, lock-and-release members, fasteners, valve assemblies, fluid moving devices, battery assemblies, alarm devices, filters, or any combination thereof.

The powered air purifying respirator may comprise one or more back plates. The back plate may function to couple the powered air purifying respirator to a strap. The back plate may be located on a back side of the PAPR housing. The back plate may be located on a side of a battery assembly opposing a fluid moving device. The back plate may be removably coupled to a strap. The back plate may be coupled to a PAPR housing via one or more fasteners, adhesives, or both. The fastener may include a screw, bolt, push pin, rivet, the like, or any combination thereof. The adhesive may include epoxy, polyurethane, cyanoacrylate, the like, or any combination thereof.

The powered air purifying respirator may comprise one or more displays. The display may function to visually display operating conditions or settings of the powered air purifying respirator, or both. The operating conditions may include battery life, filter life, airflow rate, blower speed, service time, run time, the like, or any combination thereof. The settings may include filter type, use circumstance, headpiece type, alarm type, alarm threshold, the like, or any combination thereof. Alarm type may refer to a noise, vibration, light, or any combination thereof. Alarm threshold may refer to a quantifiable operating condition, above or below which an alarm is triggered. For example, an alarm threshold may include a battery life of 10%. As another example, an alarm threshold may include a filter life of 10%. The display may be located on a back side, top side, bottom side, left side, or right side of the PAPR housing, or any combination thereof. It may be advantageous to locate the display on a top side of the PAPR housing so users may look down to view the display while the powered air purifying respirator is being worn, operational, or both. The display may be coupled to a PAPR housing via one or more fasteners, adhesives, or both. The fastener may include a screw, bolt, push pin, rivet, the like, or any combination thereof. The adhesive may include epoxy, polyurethane, cyanoacrylate, the like, or any combination thereof.

The powered air purifying respirator may include one or more buttons. The buttons may function to receive inputs from a user and convert the inputs into electrical signals. A user may interact with the buttons to direct operating conditions, settings, or both. The buttons may be located on a back side, top side, bottom side, left side, or right side of the PAPR housing, or any combination thereof. It may be advantageous to locate the buttons on a top side of the PAPR housing so users may look down to view the buttons while the powered air purifying respirator is being worn, operational, or both. The buttons may be located proximate to a display. The buttons may be provided as a unitary piece with a display.

The powered air purifying respirator may comprise one or more covers. The cover may function to protect one or more displays and/or buttons, provide an interface for a hose to attach, or both. The cover may be located over one or more displays, buttons, outlets of a PAPR housing, or any combination thereof. The cover may include a projection adapted to couple to a hose. The projection may provide an interface for a hose to attach. The projection may include a locking mechanism. The locking mechanism may include a ball-lock coupling, roller-lock coupling, pin-lock coupling, bayonet coupling, the like, or any combination thereof. A hose may be friction-fit with the projection. The cover may include an aperture extending therethrough to allow air to pass between an outlet of the PAPR housing and a hose. The cover may be coupled to a PAPR housing via one or more fasteners, adhesives, or both. The fastener may include a screw, bolt, push pin, rivet, the like, or any combination thereof. The adhesive may include epoxy, polyurethane, cyanoacrylate, the like, or any combination thereof.

The powered air purifying respirator may comprise one or more lock-and-release members. The lock-and-release members may function to retain a battery assembly. The lock-and-release members may include two lock-and-release members located on opposing sides of the PAPR housing. The lock-and-release members may be located on a back side, top side, bottom side, left side, or right side of the PAPR housing, or any combination thereof. The lock-and-release members may removably engage a battery assembly. The lock-and-release members may snap-lock the battery assembly into secure engagement with the PAPR housing. A user may manipulate a lock-and-release member to disengage a battery assembly and remove a battery assembly from a PAPR housing.

The powered air purifying respirator may comprise one or more powered air purifying respirator (PAPR) housings. The PAPR housing may function to retain one or more back plates, covers, displays, buttons, lock-and-release members, valve assemblies, fluid moving devices, battery assemblies, alarm devices, filters, or any combination thereof; provide channels for airflow; or both. The PAPR housing may comprise one or more inlets, outlets, or both. The inlet may be in fluid communication with the outlet. The inlet, outlet, or both may be in fluid communication with one or more filters, valve assemblies, fluid moving devices, or any combination thereof. The outlet may be located downstream of the inlet. The inlet of the PAPR housing may be located proximate to an inlet of a fluid moving device. The outlet of the PAPR housing may be located proximate to an outlet of a fluid moving device. One or more valve assemblies, filters, plugs, or any combination thereof may engage the inlet. A hose may engage the outlet. The inlet, outlet, or both may be located on a back side, top side, bottom side, left side, or right side of the PAPR housing, or any combination thereof. It may be advantageous to locate the outlet on the top side of the PAPR housing to provide for a generally straight hose extending between the powered air purifying respirator and a headpiece. Each inlet may be located on a separate side of the PAPR housing. It may be advantageous to provide each inlet on separate sides of the PAPR housing to provide spacing between filters. For example, a PAPR housing may comprise an inlet on a left side, an inlet on a right side, and an inlet on a bottom side. The PAPR housing may comprise one or more, two or more, or even three or more inlets. In one aspect, the PAPR housing may comprise three inlets. It may be advantageous to provide a PAPR housing with three inlets to accept three filters to provide for a suitable air supply volume to a user when filters with higher air resistance are employed. It will be appreciated by the present disclosure that while a PAPR housing may comprise three inlets, the powered air purifying respirator may be configured and re-configured to suit a variety of different use circumstances that require three or less inlets. The PAPR housing may be fabricated from polymer, metal, or both. The polymer may include polyethylene, polypropylene, polyvinylchloride, polyamide, polycarbonate, polymethylmethacrylate, the like, or any combination thereof. The metal may include aluminum, tin, iron, steel, the like, or any combination thereof. The PAPR housing may be formed by injection molding, co-injection molding, thermoforming, overmolding, the like, or any combination thereof.

The powered air purifying respirator may comprise one or more valve assemblies. The valve assembly may function to engage an inlet of a PAPR housing, a filter, a plug, or any combination thereof; allow air to flow therethrough when a filter is engaged with the valve assembly; prevent air from flowing therethrough when the valve assembly is free of engagement with a filter; or any combination thereof. The valve assembly may allow or prevent air from flowing therethrough. The allowance or prevention of airflow may be determined by the presence or absence, respectively, of a filter engaged to the valve assembly. If a valve assembly is not engaged with a filter, air may be prevented from flowing therethrough to prevent contaminants from being inhaled by a user. The valve assembly may include a valve cover and/or valve seal that forms a sealing relationship with an aperture when the valve assembly is free of engagement with a filter. The valve cover and/or valve seal may move out of a sealing relationship with the aperture when the valve assembly is engaged with a filter. The valve assembly may be removable from the PAPR housing. The valve assembly may be removed to be serviced, replaced, or both. The valve assembly may be coupled to a PAPR housing via one or more fasteners, adhesives, or both. The fastener may include a screw, bolt, push pin, rivet, the like, or any combination thereof. The adhesive may include epoxy, polyurethane, cyanoacrylate, the like, or any combination thereof. The valve assembly may comprise one or more valve assembly housings, filter portions, valve portions, apertures, grooves, shelves, projections, tracks, plugs, inner gaskets, valve supports, springs, valve covers, valve seals, valve fasteners, outer gaskets, or any combination thereof.

The valve assembly may comprise one or more valve assembly housings. The valve assembly housing may function to engage an inlet of a PAPR housing, a filter, a plug, or any combination thereof; retain one or more inner gaskets, valve supports, springs, valve covers, valve seals, valve fasteners, outer gaskets, or any combination thereof; or both. The valve assembly housing may be tubular. The valve assembly housing may include two opposing ends. The opposing ends may be open. A filter, plug, or both may engage a first end. An aperture may be located at a second end. Air may flow through the valve assembly housing. Air may flow from the first end to the second end. The valve assembly housing may be defined by a longitudinal axis extending between the opposing ends. At least a portion of the valve assembly housing may be located within an inlet of a PAPR housing. A portion of the valve assembly housing may protrude from an inlet of a PAPR housing. The valve assembly may comprise one or more filter portions, valve portions, grooves, shelves, apertures, threading, tracks, projections, or any combination thereof.

The valve assembly housing may comprise a filter portion. The filter portion may engage one or more filters, covers, or both. The filter portion may be generally tubular. The filter portion may include two opposing ends. The ends may be open. A filter, plug, or both may engage a first end. A valve portion may interface with a second end. The filter portion may be defined by a longitudinal axis extending between the opposing ends. The filter portion may be defined by an inner diameter, outer diameter, or both. The filter portion may have a greater inner diameter, outer diameter, or both relative to the valve portion, or vice versa. The inner diameter, outer diameter, or both of the filter portion may be generally equal to an inner diameter, outer diameter, or both of a valve portion. An inner perimeter of the filter portion may include threading. A cover, filter, or both may include threading that is complementary to the threading of the filter portion. The threading may include coarse threading. The threading may be configured to prevent cross-threading. At least a portion of the filter portion may be located within an inlet of a PAPR housing. A portion of the filter portion may protrude from the PAPR housing. The filter portion may include one or more grooves. The groove may be located on an outer perimeter of the filter portion. The groove may extend circumferentially around the filter portion. An outer gasket may be disposed within the groove. A shelf may be located at the second end of the filter portion. The shelf may be located proximate to an interface of the filter portion and a valve portion. The shelf may extend radially between the filter portion and the valve portion. The shelf may extend along an axis perpendicular to the longitudinal axis of the filter portion. The shelf may extend along at least a portion of the inner perimeter of the filter portion. The shelf may be generally flat. The shelf may include an inner gasket disposed thereon. The shelf may include a groove. An inner gasket may be disposed within the groove.

The valve assembly housing may comprise a valve portion. The valve portion may function to retain one or more valve supports, springs, valve covers, valve seals, valve fasteners, or any combination thereof. The valve portion may be tubular. The valve portion may include two opposing ends. The ends may be open. A filter portion may interface with a first end. An aperture may be located at a second end. The aperture may be sealed by a valve cover, valve seal, or both to prevent air from flowing therethrough. The aperture may be un-sealed to allow air to flow therethrough. A shelf may be located proximate to a second end. The shelf may be located proximate to and/or define an aperture. The shelf may extend radially from an inner perimeter of the valve portion. The shelf may extend along an axis perpendicular to the longitudinal axis of the valve portion. The shelf may extend along at least a portion of the inner perimeter of the valve portion. The shelf may be generally flat. The shelf may include a spring disposed thereon. One or more recesses may be located on a second end. The recess may extend circumferentially around the second end or at least a portion thereof. The recess may engage with a valve seal. A valve seal may deform and protrude into the recess, forming a fluid-tight seal. The valve portion may be defined by a longitudinal axis extending between the opposing ends. The valve portion may be defined by an inner diameter, outer diameter, or both. The valve portion may have a greater inner diameter, outer diameter, or both relative to the filter portion, or vice versa. The inner diameter, outer diameter, or both of the valve portion may be generally equal to an inner diameter, outer diameter, or both of a filter portion. The valve portion may include one or more grooves. The groove may be located on an outer perimeter of the valve portion. The groove may extend circumferentially around the valve portion. An outer gasket may be disposed within the groove. At least a portion of the valve portion may be located within an inlet of a PAPR housing. A portion of the valve portion may protrude from the PAPR housing. The valve portion may include one or more tracks or projections. The track or projection may be located on an inner perimeter of the valve portion. The track or projection may be parallel to a longitudinal axis of the valve portion. The track or projection may extend at least partially a length of the valve portion. The track may be formed into the valve portion. The projection may extend radially from the valve portion. The one or more tracks or projections may include pairs of tracks or projections located on opposing sides of the valve portion. The track may cooperate with a projection located on a valve support. The projection may cooperate with a track located on a valve support. The track may be slidably engaged with the projection. The projection may travel within the track. The track and projection may cooperate to prevent a valve support from rotating. The track and projection may cooperate to guide the movement of a valve support.

The valve assembly may comprise one or more outer gaskets. The outer gasket may function to provide a fluid-tight seal between a valve assembly and an inlet of a PAPR housing. The outer gasket may be disposed on an outer perimeter of a valve assembly housing. The outer gasket may be disposed within a groove. The outer gasket may be located on a valve portion, filter portion, or both. The outer gasket may be located between a valve assembly housing and an inlet of a PAPR housing. The outer gasket may have a sandwiched arrangement between a valve assembly housing and an inlet of a PAPR housing. The outer gasket may include an O-ring, flat seal, diaphragm, grommet, the like, or any combination thereof. The outer gasket may be fabricated from natural rubber, neoprene, nitrile rubber, ethylene propylene diene terpolymer, silicone, fluoroelastomer (e.g., Viton™), styrene butadiene, butadiene acrylonitrile, ethylene propylene, butyl rubber, chlorosulfonated polyethylene (e.g., Hypalon®), the like, or any combination thereof.

The valve assembly may comprise one or more inner gaskets. The inner gasket may function to provide a fluid-tight seal between a plug and shelf, or a filter and shelf. The inner gasket may be located on a valve portion, filter portion, or both. The inner gasket may be disposed on a shelf of the filter portion. The inner gasket may be located between a shelf and plug, or a shelf and filter. The inner gasket may have a sandwiched arrangement between a plug and shelf, or a filter and shelf. The inner gasket may be disposed within a groove. The inner gasket may include an O-ring, flat seal, diaphragm, grommet, the like, or any combination thereof. The inner gasket may be fabricated from natural rubber, neoprene, nitrile rubber, ethylene propylene diene terpolymer, silicone, fluoroelastomer (e.g., Viton™), styrene butadiene, butadiene acrylonitrile, ethylene propylene, butyl rubber, chlorosulfonated polyethylene (e.g., Hypalon®), the like, or any combination thereof.

The valve assembly may comprise one or more plugs. The plug may function to occupy a valve assembly when not in use, free of engagement with a filter, or both. The plug may provide a precautionary measure, secondary to a valve cover and/or valve seal, to ensure that contaminants do not enter the valve assembly. The plug may engage the filter portion of the valve assembly housing. The plug may be free of interaction with a valve support. The plug may not cause a valve cover and/or valve seal to move out of a sealing relationship with an aperture. At least a portion of the plug may be hollow. The plug may include a space in which a valve support locates when the plug is engaged with the valve assembly housing. The plug may include threading. The threading may be complementary to the threading of the filter portion. The threading may include coarse threading. The threading may be configured to prevent cross-threading. The plug may cooperate with an inner gasket of a filter portion to provide a fluid-tight seal.

The valve assembly may comprise one or more valve supports. The valve support may function to retain a valve cover, guide movement of the valve cover, or both. The valve support may be located within a valve assembly housing. The valve support may be located in a filter portion, valve portion, or both. The valve support may be tubular. The valve support may include two opposing ends. The ends may be open. Air may flow through the valve support. An outer diameter of the valve support may be generally equal to an inner diameter of a filter portion, valve portion, or both. The valve support may engage with a spring, valve cover, valve fastener, or any combination thereof. The spring may be disposed between a valve support and a shelf of the valve portion. The spring may bias the valve support away from an aperture causing a valve cover and/or valve seal to seal an aperture. The spring may be compressed by a valve support upon a filter engaging the valve support causing a valve cover and/or valve seal to un-seal an aperture. The valve support may include a channel. The channel may accept a valve cover, valve fastener, or both. The channel may be co-linear with a longitudinal axis of the valve support. The channel may extend through a center of the valve support. The channel may extend between opposing ends of the valve support. The valve support may include one or more structural ribs. The structural ribs may support the channel, structurally reinforce the valve support, or both. The structural ribs may be parallel to a longitudinal axis of the valve support. The structural ribs may extend transversely within an inner perimeter of the valve support. The structural ribs may extend between opposing ends of the valve support or at least a portion thereof. The structural ribs may allow air to flow therebetween. The valve support may include one or more tracks or projections. The track or projection may be located on an outer perimeter of the valve support. The track or projection may be parallel to a longitudinal axis of the valve support. The track or projection may extend at least partially a length of the valve support. The track may be formed into the valve support. The projection may extend radially from the valve support. The one or more tracks or projections may include pairs of tracks or projections located on opposing sides of the valve support. The track may cooperate with a projection located on a valve portion. The projection may cooperate with a track located on a valve portion. The track may be slidably engaged with the projection. The projection may travel within the track. The track and projection may cooperate to prevent a valve support from rotating. The track and projection may cooperate to guide the movement of a valve support.

The valve assembly may comprise one or more springs. The spring may function to move a valve cover and/or valve seal into and out of a sealing relationship with an aperture. The spring may include a compression spring. The spring may be located within a valve portion of a valve assembly. The spring may be defined by a diameter. The diameter may be generally equal to an inner diameter of the valve portion of the valve assembly. The spring may be disposed on a shelf of the valve portion of a valve assembly. The spring may be located between a valve support and a shelf of a valve portion of a valve assembly. The spring may bias the valve support away from an aperture causing a valve cover and/or valve seal to seal an aperture. The spring may be compressed by a valve support upon a filter engaging the valve support causing a valve cover and/or valve seal to un-seal an aperture.

The valve assembly may comprise one or more valve covers. The valve cover may function to form a sealing relationship with an aperture, allow air to flow through an aperture when a filter is engaged with a valve assembly, prevent the air from flowing through an aperture when the valve assembly is free of engagement with the filter, or any combination thereof. The valve cover may be generally conical. The valve cover may include a curvature along its length. The valve cover may include two opposing ends. A vertex may be located at a first end. The vertex may be truncated. The vertex may engage a valve support. A base may be located at a second end. The base may move into and out of a sealing relationship with an aperture. The valve cover may be defined by a longitudinal axis extending between the vertex and the base. The base may be located exterior to the valve assembly housing. The base may be defined by a diameter. The diameter may be greater than a diameter of an aperture. The valve cover may include a channel. The channel may be co-linear with a longitudinal axis of the valve cover. The channel may include opposing ends. The ends may be open. The channel may accept a valve fastener. The valve fastener may include a screw, bolt, push pin, rivet, the like, or any combination thereof. The valve fastener may extend through the channel. A portion of the valve fastener may protrude from a vertex of the valve cover. The portion of the valve fastener protruding from the vertex of the valve cover may engage a valve support. The channel may extend through a center of the valve cover. The channel may extend along a length of the valve cover, or at least a portion thereof. A valve seal may be coupled to the base.

The valve assembly may comprise one or more valve seals. The valve seal may function to form a sealing relationship with an aperture, allow air to flow through an aperture when a filter is engaged with a valve assembly, prevent air from flowing through an aperture when a valve assembly is free of engagement with a filter, or any combination thereof. The valve seal may be cylindrical. The valve seal may include two opposing ends. The ends may be open. Opposing ends of the valve seal may form a sandwiching arrangement with a base of a valve cover. The valve seal may be coupled to a base of a valve cover. The valve seal may be deformable. The valve seal may be applied to the base of a valve cover by manipulating one end over the base and locating the base between the opposing ends of the valve seal. The valve seal may be located exterior to the valve assembly housing. The valve seal may engage an end of the valve assembly housing proximate to an aperture. The valve seal may form a fluid-tight engagement with an end of the valve assembly housing. Upon engaging a filter with a valve support, the valve seal may separate from an end of the valve assembly housing allowing air to flow through an aperture. The valve seal may be fabricated from natural rubber, neoprene, nitrile rubber, ethylene propylene diene terpolymer, silicone, fluoroelastomer (e.g., Viton™), styrene butadiene, butadiene acrylonitrile, ethylene propylene, butyl rubber, chlorosulfonated polyethylene (e.g., Hypalon®), the like, or any combination thereof.

The powered air purifying respirator may comprise one or more fluid moving devices. The fluid moving device may function to draw air through one or more filters, deliver air to a user, or both. The fluid moving device may include an axial fan, radial fan, or both. The fluid moving device may operate by a stator driving a rotor. The rotor may draw air through an inlet of the fluid moving device and direct air through an outlet of the fluid moving device. The rotor may operate at a speed. The speed may be measured in rotations per minute (RPM). The speed may be adjustable. The speed may be directed by one or more airflow sensors. The speed may be determined by an air resistance of one or more filters. The powered air purifying respirator of the present disclosure may prolong battery life by directing a fluid moving device to operate at a speed tailored to filter type, filter life, or both. As a result, the fluid moving device may avoid operating at elevated speeds that are unnecessary for a particular filter type, filter life, or both. The fluid moving device may cooperate with an airflow sensor to continuously alter speed during operation of the powered air purifying device to ensure the speed is suitable to the filter type, filter life, or both. The inlet may be located proximate to one or more inlets of a PAPR housing. The outlet may be located proximate to an outlet of a PAPR housing. The fluid moving device may comprise one or more fluid moving device housings, inlets, outlets, airflow sensor retaining members, rotors, stators, printed circuit boards, alarm devices, airflow sensors, or any combination thereof.

The fluid moving device may comprise a fluid moving device housing. The fluid moving device housing may function to retain one or more stators, rotors, printed circuit boards, alarm devices, airflow sensors, or any combination thereof. The fluid moving device housing may be provided as two separate pieces that are coupled together. The fluid moving device housing may provide one or more channels for air to travel through. The fluid moving device housing may define an inlet, outlet, or both. The inlet may be located proximate to a rotor. The outlet may be located downstream of the inlet. The outlet may be defined by a first and/or second central transverse axis. The first and/or second central transverse axis may be perpendicular to a longitudinal axis of an airflow channel proximate to the outlet. The first and/or second central transverse axis may be perpendicular to an airstream exiting an outlet of the fluid moving device. The fluid moving device housing may be fabricated from polymer, metal, or both. The polymer may include polyethylene, polypropylene, polyvinylchloride, polyamide, polycarbonate, polymethylmethacrylate, the like, or any combination thereof. The metal may include aluminum, tin, iron, steel, the like, or any combination thereof. The fluid moving device housing may be formed by injection molding, co-injection molding, thermoforming, overmolding, the like, or any combination thereof. The fluid moving device housing may comprise one or more airflow sensor retaining members. The fluid moving device may be coupled to a PAPR housing. The fluid moving device may be coupled via one or more fasteners, adhesives, or both. The fastener may include a screw, bolt, push pin, rivet, the like, or any combination thereof. The adhesive may include epoxy, polyurethane, cyanoacrylate, the like, or any combination thereof.

The fluid moving device may comprise a printed circuit board (PCB). The printed circuit board may function to provide power to the fluid moving device, control the operation of the fluid moving device, communicate with an airflow sensor, communicate with an alarm device, or any combination thereof. The printed circuit board may include a controller. The controller may receive inputs from an airflow sensor. The controller may direct an operation of the fluid moving device, alarm device, or both. The printed circuit board may be annular. The printed circuit board may be co-linear with an inlet of the fluid moving device. The printed circuit board may be located within a fluid moving device housing. At least a portion of the printed circuit board may protrude radially from the fluid moving device housing. The portion of the printed circuit board protruding from the fluid moving device housing may provide connections for power, data exchange, or both.

The fluid moving device may comprise one or more airflow sensor retaining members. The airflow sensor retaining member may function to retain an airflow sensor, provide a consistent location for locating airflow sensors across different fluid moving devices, or both. The airflow sensor retaining member may be integrally molded to an airflow moving device housing, coupled to an airflow moving device housing, or both. The airflow sensor retaining member may be coupled via one or more fasteners, adhesives, or both. The fastener may include a screw, bolt, push pin, rivet, the like, or any combination thereof. The adhesive may include epoxy, polyurethane, cyanoacrylate, the like, or any combination thereof. The airflow sensor retaining member may include a recess formed into a fluid moving device housing, one or more projections extending from the fluid moving device housing, or both. The one or more projections may protrude into an airflow channel of the fluid moving device housing. The projection may include one or more tabs. The tab may function to latch onto an airflow sensor. The tab may be located on an end of the projection opposing the base of the projection or anywhere between an end of the projection and a base of the projection. The base of the projection may refer to the interface of the projection with the fluid moving device housing. The projection, tab, or both may be deformable. The projection may extend from the fluid moving device housing at an angle. The tab may extend from the projection at an angle. The angle may be about 5° or more, 10° or more, 30° or more, or even 50° or more. The angle may be about 175° or less, 170° or less, 150° or less, or even 130° or less. For example, a projection may extend at 90° from a fluid moving device housing and a tab may extend 90° from the projection. The airflow sensor may interface with one or more sides of an airflow sensor. The airflow sensor retaining member may contour an airflow sensor. The airflow sensor retaining member may be located proximate to an outlet of a fluid moving device. The airflow sensor retaining member may be located within an airflow channel of a fluid moving device housing. The airflow sensor retaining member may interface with an outlet of a fluid moving device. The airflow sensor retaining member may be formed by injection molding, co-injection molding, thermoforming, overmolding, the like, or any combination thereof. The airflow sensor retaining member may be fabricated from the same or different material as the fluid moving device. The airflow sensor retaining member may be fabricated from polymer, metal, or both. The polymer may include polyethylene, polypropylene, polyvinylchloride, polyamide, polycarbonate, polymethylmethacrylate, the like, or any combination thereof. The metal may include aluminum, tin, iron, steel, the like, or any combination thereof.

The fluid moving device may comprise one or more airflow sensors. The airflow sensor may function to measure airflow. The airflow sensor may communicate with a controller of a fluid moving device. The airflow sensor may direct the controller to change a speed of a fluid moving device. The airflow sensor may include an amplified airflow sensor, unamplified airflow sensor, or both. A non-limiting example of a suitable airflow sensor may include the FS7002-cn-VC3b, commercially available from Siargo Ltd. The airflow sensor may measure airflow during operation of a powered air purifying respirator, fluid moving device, or both. The airflow sensor may measure airflow continuously, upon commencing operation of a powered air purifying respirator, upon direction from a user, upon installation of a filter, at time intervals, or any combination thereof. The time interval may be about 1 second or more, 5 seconds or more, 30 seconds or more, or even 1 minute or more. The time interval may be about 1 hour or less, 50 minutes or less, 30 minutes or less, or even 10 minutes or less. The airflow sensor may be located proximate to an outlet of a fluid moving device, outlet of a PAPR housing, or both. The airflow sensor may interface with an outlet of a fluid moving device. The airflow sensor may be coupled to an airflow sensor retaining member. At least a portion of the airflow sensor may be recessed within a fluid moving device. At least a portion of the airflow sensor may protrude into an airflow channel of a fluid moving device. The airflow sensor may include an inlet, outlet, or both. The inlet, outlet, or both may be co-linear. The inlet, outlet or both may be offset from a first and/or second central transverse axis of an outlet of a fluid moving device. The location of the airflow sensor, inlet of the airflow sensor, outlet of the airflow sensor, or any combination thereof within the powered air purifying respirator may determine the repeatability of the measurements sensed by the airflow sensor. Without being bound by theory, differing air resistance of different filters, or even the same filter at different points in time during its service life, may cause an air stream flowing within the fluid moving device to vary in its properties. It is contemplated by the present disclosure that locating the airflow sensor proximate to an outlet of a fluid moving device and offsetting the inlet, outlet, or both of an airflow sensor with respect to both a first and/or second central transverse axis of the outlet may provide for repeatable (precise) measurements of airflow across a variety of different filters. For powered air purifying respirators employing more than one filter, it may be advantageous to provide the airflow sensor at a point in an airstream that is downstream of the filters and in fluid communication with all of the filters to characterize the air resistance of all filters rather than one or more individual filters. The airflow sensor may be coupled to a fluid moving device, airflow sensor retaining member, or both via one or more fasteners, adhesives, or both. The fastener may include a screw, bolt, push pin, rivet, the like, or any combination thereof. The adhesive may include epoxy, polyurethane, cyanoacrylate, the like, or any combination thereof. The airflow sensor may be friction-fit, snap-fit, or both into an airflow sensor retaining member.

The powered air purifying respirator may comprise one or more alarm devices. The alarm device may function to alert a user to one or more operating conditions of the powered air purifying respirator operating under a certain threshold. For example, the alarm device may alert a user to low battery, low filter life, a filter not properly installed, or any combination thereof. The alarm device may emit sound, generate vibration, produce light, or any combination thereof. It may be advantageous to alert a user via any combination of sound, vibration, or light to ensure a user is notified of an operating condition. The sound, vibration, light, or any combination thereof may be attributed to a particular operating condition or threshold of an operating condition. In this manner, a user may determine an operating condition by the sound, vibration, light, or any combination thereof without referencing a display or otherwise investigating the cause of the alert. For example, an alarm device may produce a vibration when a battery is at 50% charge and two alarm devices may produce a vibration and sound respectively when a battery is at 10% charge. The alarm device may be coupled to a fluid moving device housing, PAPR housing, or both. The alarm device may communicate with one or more airflow sensors, fluid moving devices, or both.

The powered air purifying respirator may comprise one or more battery assemblies. The battery assembly may function to provide power to the air purifying respirator, fluid moving device, display, buttons, or any combination thereof. The battery assembly may be rechargeable, replaceable, or both. The battery assembly may include a lithium-ion battery, nickel cadmium battery, nickel metal hydride battery, the like, or any combination thereof. The battery assembly may be located on a back side of a PAPR housing. The battery assembly may be located adjacent to a fluid moving device. The battery assembly may be located between a fluid moving device and a back plate of a PAPR housing. The battery assembly may engage one or more lock-and-release members. One or more lock-and-release members may form a snap-lock with the battery assembly. The battery assembly may install axially from a top side of the PAPR housing. The battery assembly may travel axially toward a bottom side of a PAPR housing, into engagement with one or more lock-and-release members.

The powered air purifying respirator may comprise one or more filters. The one or more filters may function to neutralize contaminants. The filter may satisfy the British Standard (BS) EN 14387:2004+A1:2008, Respiratory protective devices; Gas filter(s) and combined filter(s); Requirements, testing, marking, published February 2004, incorporated herein by reference for all purposes. The filter may satisfy the United States equivalent to the BS EN 14387:2004+A1:2008. The filter may be designated by a rating according to BS EN 14387:2004+A1:2008. The rating may include a letter and numeral, or a string thereof. The letter may designate what and which type of chemicals, pathogens, particulates, or any combination thereof are neutralized by the filter. “A” may refer to organic gasses; “B’ may refer to inorganic gasses and vapors; “E” may refer to sulfur dioxide; “K” may refer to ammonia and organic ammonia derivatives; “CO” may refer to carbon monoxide; “Hg” may refer to mercury; “NO” may refer to nitrous gasses “P” may refer to aerosol particles. The number may designate the level of protection against said chemical, pathogen, and/or particulate. For example, a P1 filter may neutralize about 80% of particles (P) smaller than 2 μm and a P3 filter may neutralize about 99.95% of particles (P) smaller than 0.5 μm. The filter may include a P1 filter, P2 filter, P3 filter, A2P3 filter, A2B2P3 filter, A2B2E2P3 filter, A2B2E2K2P3 filter, A2BE1K2HgP3 filter, the like, or any combination thereof. The filter may be characterized by an inhalation resistance, exhalation resistance, or both. Inhalation resistance, exhalation resistance, or both may be referred to herein as air resistance. An exemplary standard for air resistance of filters is set forth in 42 C.F.R. § 84.178. If inhalation resistance is too high, then not enough oxygen may be available to a user. If exhalation resistance is too high, then carbon dioxide may not be expelled, and a user may re-respirate the carbon dioxide. Air resistance may vary between different types of filters. The air resistance may be determined by the material, pore size, or thickness of a substrate employed by the filter, or any combination thereof. The air resistance may determine a speed of a fluid moving device. For example, a speed of a fluid moving device may increase generally proportionally to an increase in air resistance. Air resistance may increase during the service life of a filter. During the service life of a filter, chemicals, pathogens, particulates, or any combination thereof may accumulate in the filter, impeding the flow of air. During the service life of a filter, a speed of a fluid moving device may increase incrementally over time. The number of filters employed with a powered air purifying respirator may be determined by the occupational setting in which the user is working, the rating of a filter, or both. The valve assembly of the present disclosure allows users to use the powered air purifying respirator in any type of occupational setting and employ filters having any type of rating. In this manner, the powered air purifying respirator provides users with a multi-functional solution. For example, a powered air purifying respirator may be used in one occupational setting and employ one filter and airflow through any other inlets that are not engaged with a filter may be prevented. The same powered air purifying respirator may be used in a different occupational setting and employ three filters.

The present disclosure provides for a method of operating a powered air purifying respirator. The method may comprise one or more of the following steps. Some of the steps may be duplicated, removed, rearranged relative to other steps, combined into one or more steps, separated into two or more steps, or any combination thereof. The method for operating a powered air purifying respirator may comprise receiving a first filter at a first time, sensing an airflow, and directing a blower speed based upon the airflow. The method may further comprise receiving a second filter at a second time and repeating the sensing step and the directing step for the second filter. The receiving step, sensing step, directing step, or any combination thereof may be performed for any number of subsequent filters at any number of subsequent times. The filter may be characterized by different ratings according to BS EN 14387:2004+A1:2008. The filters may be received by the powered air purifying respirator. The sensing step may be performed by an airflow sensor. The sensing step may be performed autonomously. The directing step may be performed by a controller. The controller may be in communication with the airflow sensor. The directing step may be performed autonomously. As referred to herein, autonomous may mean without user direction, interaction, or both. The sensing step and/or directing step may be performed in substantially real-time upon receiving a filter. As referred to herein, real-time may mean an action that occurs substantially immediately after another related action.

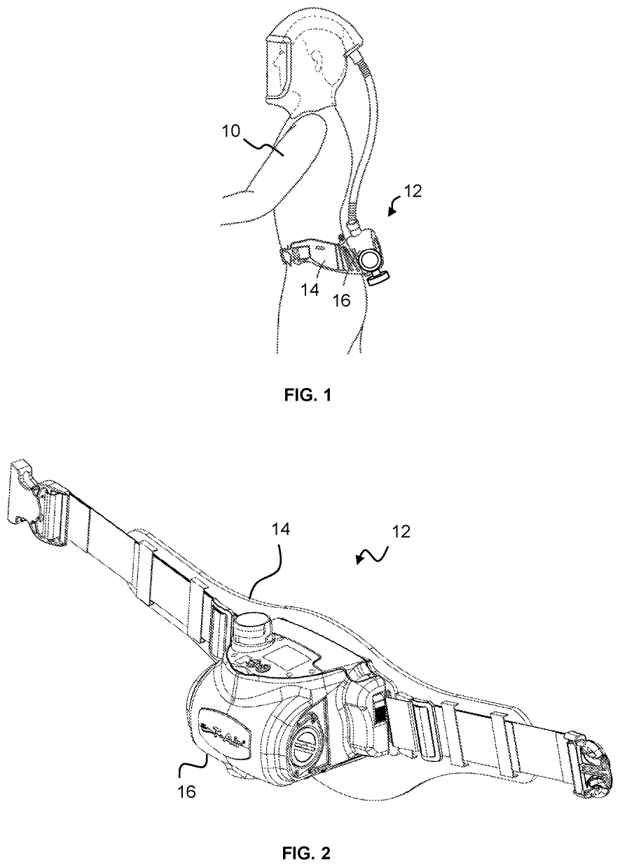

FIGS. 1 and 2 illustrate a respirator assembly 12. The respirator assembly 12 comprises a strap 14 and a powered air purifying respirator 16. The strap 14 is worn around a waist of the user 10, as shown in FIG. 1. The powered air purifying respirator 16 is coupled to the strap 14.

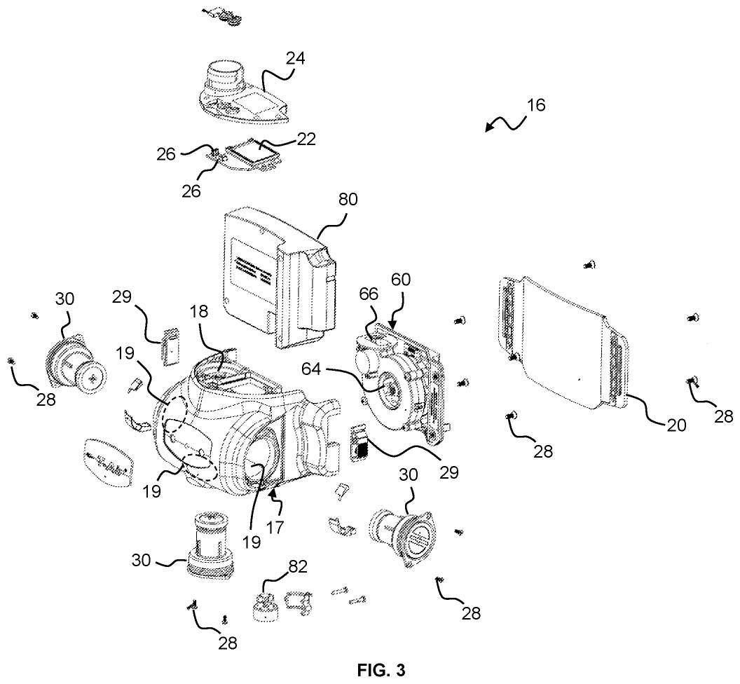

FIG. 3 is an exploded view of a powered air purifying respirator 16. The powered air purifying respirator 16 comprises a PAPR housing 17, three valve assemblies 30, a fluid moving device 60, and a battery assembly 80. The PAPR housing 17 comprises three inlets 19. Two of the inlets 19 are located on opposing sides of the PAPR housing 17 and a third inlet 19 is located on a bottom side of the PAPR housing 17. Each of the inlets 19 accept one of the valve assemblies 30. Fasteners 28 couple the valve assemblies 30 to the PAPR housing 17. The PAPR housing 17 further comprises an outlet 18 located on a top side of the PAPR housing 17. The outlet 18 is in fluid communication with the three inlets 19. The fluid moving device 60 includes an inlet 64 and an outlet 66. The inlet 64 of the fluid moving device 60 fluidly communicates with the three inlets 19 of the PAPR housing 17 and the three valve assemblies 30. The outlet 66 of the fluid moving device 60 locates proximate to the outlet 18 of the PAPR housing 17. The outlet 66 fluidly communicates with the inlet 64 of the fluid moving device, the inlets 19 of the PAPR housing 17, and the valve assemblies 30. During operation of the powered air purifying respirator 16, the fluid moving device 60 draws air into the PAPR housing 17 through filters 84, as shown in FIG. 10, through the valve assemblies 30, through the inlet 19 of the PAPR housing 17, and into the inlet 64 of the fluid moving device 60. The fluid moving device 60 directs the air out of the outlet 66 of the fluid moving device 60 and through the outlet 18 of the PAPR housing 17. The fluid moving device 60 is located inside the PAPR housing 17 through a back side of the PAPR housing 17. Fasteners 28 affix the fluid moving device 60 to the PAPR housing 17.

The powered air purifying respirator 16 further comprises a display 22 and buttons 26. The display 22 and buttons 26 are located on the top side of the PAPR housing 17 proximate to the outlet 18. The display 22 and buttons 26 allow users to view operational statuses of the powered air purifying respirator 16 and change operating conditions and settings of the same.

The powered air purifying respirator 16 further comprises a cover 24, back plate 20, and two lock-and-release members 29. The cover 24 is located onto a top side of the PAPR housing 17 over the display 22, buttons 26, and outlet 18. Two lock-and-release members 29 are located on opposing sides of the PAPR housing 17. The battery assembly 80 is located on a back side of the PAPR housing 17 adjacent to the fluid moving device 60. The battery assembly 80 engages the two lock-and-release members 29, which snap-lock the battery assembly 80 into secure engagement with the PAPR housing 17. The back plate 20 is located on the back side of the PAPR housing 17, on a side of the battery assembly 80 opposing the fluid moving device 60. Fasteners 28 affix the back plate 20 to the PAPR housing 17. The battery assembly 80 installs from a top side of the PAPR housing 17 and travels axially, toward a bottom side of the PAPR housing 17, into engagement with the lock-and-release members 29. The battery assembly 80 can be removed from engagement with the PAPR housing 17 by manipulating the lock-and-release members 20 and drawing the battery assembly 80 axially away from the bottom side of the PAPR housing 17. The powered air purifying respirator 16 further comprises an alarm device 82 located within the PAPR housing 17.

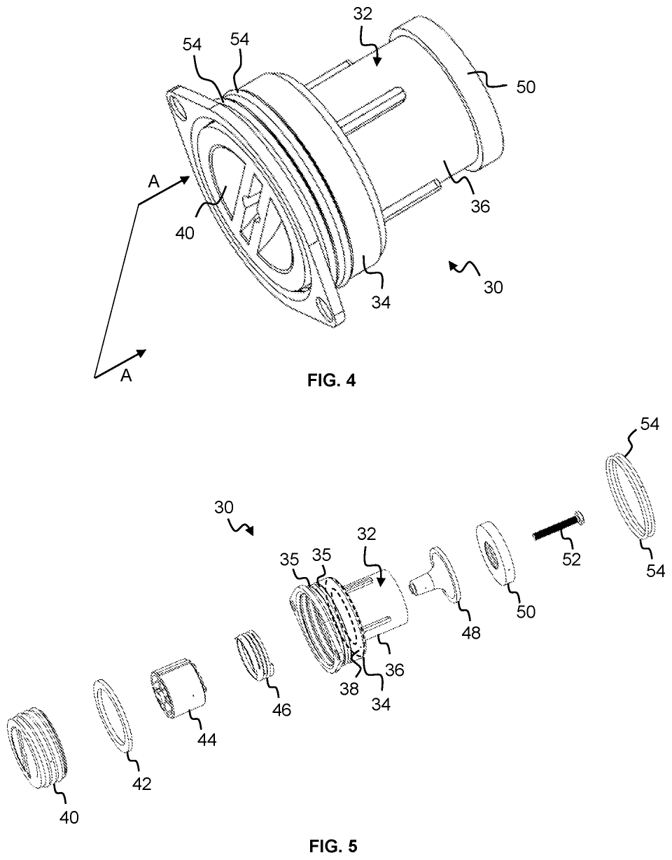

FIG. 4 is a perspective view of a valve assembly 30. The valve assembly 30 comprises a valve assembly housing 32, plug 40, and valve seal 50. The valve assembly housing 32 includes a filter portion 34 and valve portion 36. The filter portion 34 accepts the plug 40 or a filter 84, as shown in FIG. 10. The plug 40 may occupy the filter portion 34 in place of a filter 84 to prevent contaminated air from entering the valve assembly 30. The valve portion 36 retains a valve support 44, spring 46, valve cover 48, valve seal 50, and valve fastener 52, as shown in FIG. 5. The valve assembly housing 32 includes two opposing ends. The plug 40 is located on one end of the valve assembly housing 32 and the valve seal 50 is located on an opposing end of the valve assembly housing 32. Two outer gaskets 54 are located on and extend circumferentially around the filter portion 34 proximate to an end of the valve assembly housing 32. The two outer gaskets 54 ensure a fluid-tight seal between the valve assembly 30 and the inlet 19 of the PAPR housing 17, as shown in FIG. 3.

FIG. 5 is an exploded view of a valve assembly 30. The valve assembly 30 comprises a valve assembly housing 32, which includes a filter portion 34 and valve portion 36. The filter portion 34 accepts a plug 40 or filter 84, as shown in FIG. 10. The plug 40 may occupy the filter portion 34 in place of a filter 84 to prevent contaminated air from entering the valve assembly 30. An inner perimeter of the filter portion 34 is threaded and the plug 40 and filter 84 include complementary threading so the plug 40 and filter 84 can be screwed into engagement with the filter portion 34. The filter portion 34 has a greater inner diameter and outer diameter as compared to the inner diameter and outer diameter of the valve portion 36. A shelf 38 is located at the interface of the filter portion 34 and valve portion 36. The shelf 38 extends radially inward from the filter portion 34 to the valve portion 36. An inner gasket 42 locates onto the shelf 38. The inner gasket 42 forms a fluid-tight seal with the plug 40 or filter 84, as shown in FIG. 10. The filter portion 34 includes two grooves 35 extending circumferentially around the filter portion 34. Two outer gaskets 54 are located within the two grooves 35, respectively. The two outer gaskets 54 ensure a fluid-tight seal between the valve assembly 30 and the inlet 19 of the PAPR housing 17, as shown in FIG. 3. The valve portion 36 retains a valve support 44, spring 46, valve cover 48, valve seal 50, and valve fastener 52. The spring 46 locates between the valve support 44 and valve portion 36. The valve cover 48 is coupled to the valve support 44 by a valve fastener 52. The valve seal 50 locates onto the valve cover 48.

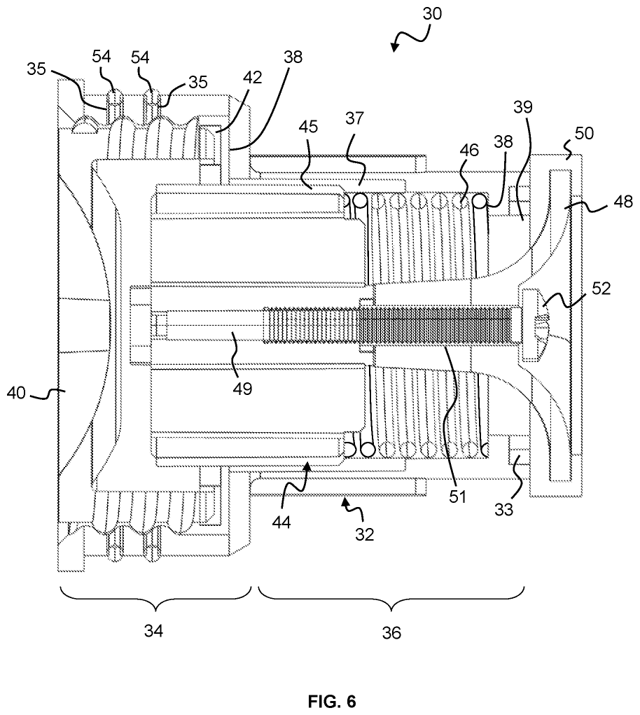

FIG. 6 is a cross-sectional view of the valve assembly 30 illustrated in FIG. 4, along line A-A. The valve assembly 30 comprises a valve assembly housing 32, which includes a filter portion 34 and a valve portion 36. Two grooves 35 are located on an outer perimeter of the filter portion 34 and outer gaskets 54 are located within the grooves 35. A plug 40 is located within the filter portion 34. The filter portion 34 further includes a shelf 38 and an inner gasket 42 is disposed on the shelf 38. The inner gasket 42 is in a sandwiched arrangement between the plug 40 and the shelf 38. The valve portion 36 retains a valve support 44, valve cover 48, valve seal 50, valve fastener 52, and spring 46. The valve seal 50 is disposed on the valve cover 48. The valve support 44 includes a channel 49 co-linear with a longitudinal axis of the valve support 44 and the valve cover 48 includes a channel 51 co-linear with a longitudinal axis of the valve cover 48. The valve cover 48 is coupled to the valve support 44 via the valve fastener 52, which extends through the channel 51 of the valve cover 48 and into the channel 49 of the valve support 44. A spring 46 is disposed between the valve support 44 and a shelf 38 of the valve portion 36. The valve portion 36 includes a track 37 and the valve support 44 includes a projection 45. The projection 45 is located within and forms a sliding engagement with the track 37. When the valve support 44 is free of engagement with a filter 84, as shown in FIG. 10, the spring biases the valve support 44 away from the aperture 39 formed in an end of the valve portion 36. Upon installing a filter 84 in the filter portion 34, the filter 84 engages the valve support 44 and pushes the valve support 44 toward the aperture 39 formed in the end of the valve portion 36, compressing the spring 46. As the valve support 44 moves toward the aperture 39, the valve seal 50 disengages from an end of the valve portion 36 and allows air to flow through the aperture 39. The plug 40 provides a space therein so that when the plug 40 is installed in the filter portion 34, the plug 40 does not engage the valve support 44 and the aperture 39 remains sealed by the valve seal 50. The valve portion 36 further comprises a recess 33 located at an end of the valve portion 36, proximate to the aperture 39. The recess 33 engages with the valve seal 50 and the valve seal 50 may deform and partially protrude into the recess 33.

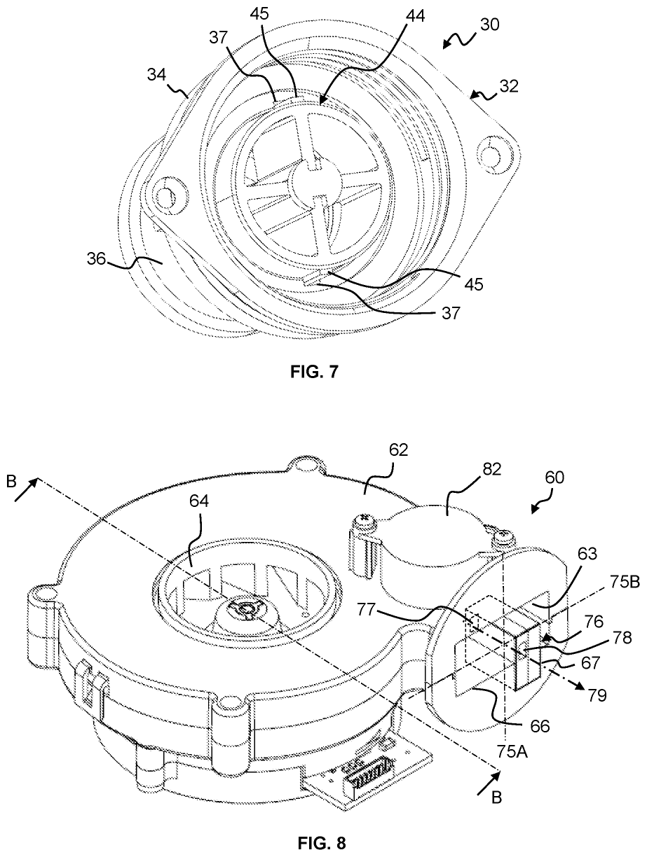

FIG. 7 is a perspective view of a valve assembly 30. The valve assembly 30 comprises a valve assembly housing 32, including a filter portion 34 and a valve portion 36. A valve support 44 is located within the valve assembly housing 32 and a portion thereof protrudes into both the filter portion 34 and valve portion 36. The valve portion 36 comprises two tracks 37. The tracks 37 are located on opposing sides of the valve portion 36. The valve support 44 comprises two projections 45. The projections 45 are located on opposing sides of the valve support 44. The projections 45 are slidably engaged with the tracks 37. The valve support 44 moves axially between opposing ends of the valve assembly housing 32, guided by the engagement of the tracks 37 and projections 45.

FIG. 8 is a perspective view of a fluid moving device 60. The fluid moving device 60 comprises a fluid moving device housing 62, which defines an inlet 64 and an outlet 66. Fluid enters the fluid moving device housing 62 through the inlet 64, travels through the fluid moving device housing 62, and exits through the outlet 66. An airflow sensor retaining member 67 is a recess formed in the fluid moving device housing 62. A portion of an airflow sensor 76 is located within the airflow sensor retaining member 67. A portion of the airflow sensor 76 protrudes into an airflow channel 63 proximate to the outlet 66. The outlet 66 is defined by a first central transverse axis 75A and a second central transverse axis 75B. The first central transverse axis 75A is oriented perpendicular to the second central transverse axis 75A. The first central transverse axis 75A and second central transverse axis 75B are oriented perpendicular to an airstream 79 flowing through the outlet 66 of the fluid moving device 60. The airflow sensor 76 is located proximate to and interfaces with the outlet 66. The airflow sensor 76 comprises an inlet 77 and an outlet 78. The inlet 77 and outlet 78 are offset a length with respect to the first central transverse axis 75A and offset a length with respect to the second central transverse axis 75B. The fluid moving device 60 further includes an alarm device 82 coupled thereto. Certain operating conditions of the fluid moving device 50 trigger the operation of the alarm device 82.

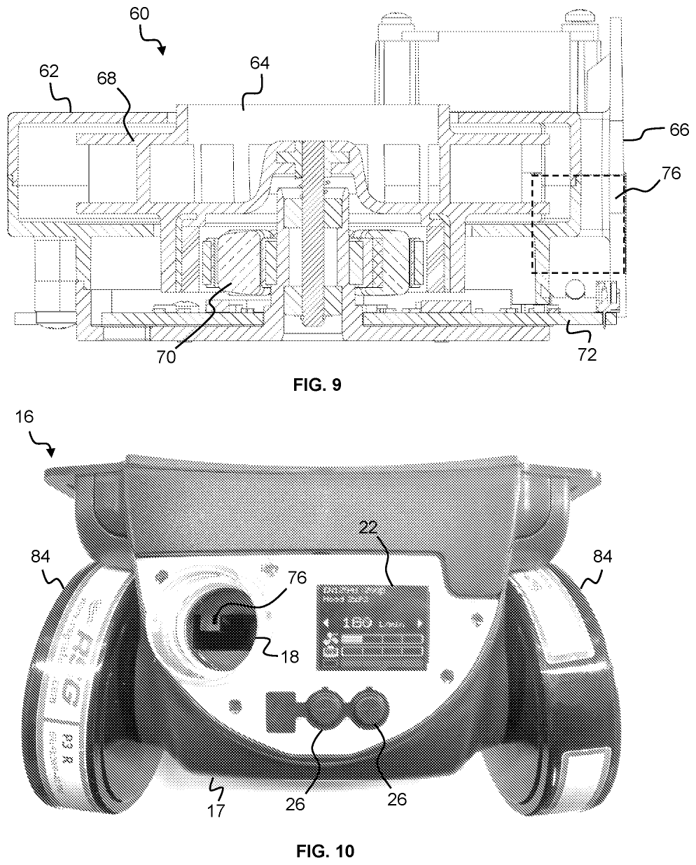

FIG. 9 is a cross-sectional view of the fluid moving device 60 illustrated in FIG. 8, along line B-B. The fluid moving device 60 comprises a fluid moving device housing 62, rotor 68, and stator 70. The fluid moving device housing 62 defines an inlet 64 and an outlet 66. The stator 70 drives rotation of the rotor 68, drawing fluid into the fluid moving device housing 62 through the inlet 64. The rotor 68 moves fluid radially outward and to the outlet 66. The fluid moving device 60 further comprises an airflow sensor 76 located proximate to the outlet 66. The fluid moving device 60 further comprises a printed circuit board 72, which controls the operation of the fluid moving device 60.

FIG. 10 is a perspective view of a powered air purifying respirator 16. The powered air purifying respirator 16 comprises a PAPR housing 17, display 22, buttons 26, outlet 18, and an airflow sensor 76. The display 22 allows users 10 to view the operating conditions and settings of the powered air purifying respirator 16. The user 10 interacts with the buttons 26 to view and/or change operating conditions and settings of the powered air purifying respirator 16. Two filters 84 are coupled to the powered air purifying respirator 16 via valve assemblies 30, as shown in FIG. 3. Fluid enters the powered air purifying respirator 16 via the filters 84 and exits the powered air purifying respirator 16 via the outlet 18. The airflow sensor 76 is located proximate to the outlet 18.

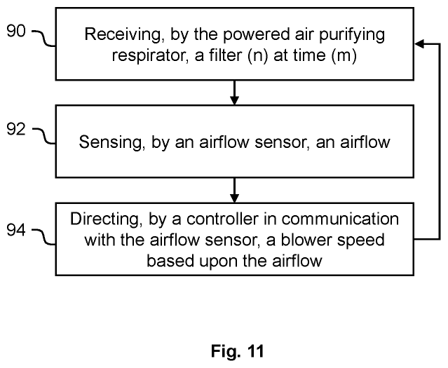

FIG. 11 illustrates a flow chart of the method of the present disclosure. The method comprises receiving, by the powered air purifying respirator, a first filter at a first time 90; sensing, by an airflow sensor, an airflow 92; and autonomously directing, by a controller in communication with the airflow sensor, a blower speed based upon the airflow 94. The method may be repeated for a second filter at a second time or any number (n) of subsequent filters at any subsequent time (m).

It is understood that any of the method steps can be performed in virtually any order. Moreover, one or more of the following method steps can be combined with other steps; can be omitted or eliminated; can be repeated; and/or can separated into individual or additional steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

### REFERENCE NUMERALS

10 User
12 Respirator assembly
14 Strap
16 Powered air purifying respirator (PAPR)
17 PAPR Housing
18 Outlet of the PAPR housing
19 Inlet of the PAPR housing
20 Back plate
22 Display
24 Cover
26 Button
28 Fastener
29 Lock-and-release member
30 Valve assembly
32 Valve assembly housing
33 Recess
34 Filter portion
35 Groove
36 Valve portion
37 Track
38 Shelf
39 Aperture
40 Plug
42 Inner gasket
44 Valve support
45 Projection
46 Spring
48 Valve cover
49 Channel of the valve support
50 Valve seal
51 Channel of the valve cover
52 Valve fastener
54 Outer gasket
60 Fluid moving device
62 Fluid moving device housing
63 Airflow channel
64 Inlet of the fluid moving device
66 Outlet of the fluid moving device
67 Airflow sensor retaining member
68 Rotor
70 Stator
72 Printed circuit board (PCB)
75A First central transverse axis
75B Second central transverse axis
76 Airflow sensor
77 Inlet of the airflow sensor
78 Outlet of the airflow sensor
79 Airstream
80 Battery assembly
82 Alarm device
84 Filter
90 Receiving a filter (n) at time (m)
92 Sensing an airflow
94 Directing a blower speed based upon the airflow

What is claimed is:

1. A powered air purifying respirator comprising:
a fluid moving device comprising:
an outlet,
an airflow sensor retaining member located proximate to the outlet, and
an airflow sensor engaged with the airflow sensor retaining member.

2. The powered air purifying respirator according to claim 1, wherein the airflow sensor retaining member is integrally formed in and/or on the fluid moving device.

3. The powered air purifying respirator according to claim 2, wherein the airflow sensor retaining member is a groove formed in the fluid moving device.

4. The powered air purifying respirator according to claim 3, wherein at least a portion of the airflow sensor is recessed within the groove.

5. The powered air purifying respirator according to claim 1, wherein the airflow sensor comprises an inlet and an outlet; and
wherein the inlet and/or the outlet are offset from a first central transverse axis of the outlet by a length and offset from a second transverse axis of the outlet by a length.

6. The powered air purifying respirator according to claim 1, wherein the outlet of the fluid moving device is in fluid communication with one or more filters.

7. The powered air purifying respirator according to claim 6, wherein the one or more filters are chosen from a plurality of different types of filters; and
wherein each of the plurality of different types of filters are characterized by a different rating according to BS EN 14387:2004+A1:2008.

8. The powered air purifying respirator according to claim 7, wherein a location of the airflow sensor provides for a measurement of airflow that is repeatable between the plurality of different types of filters.

9. The powered air purifying respirator according to claim 1, wherein the fluid moving device is a radial fan.

10. The powered air purifying respirator according to claim 1, wherein the powered air purifying respirator further comprises an outlet; and
wherein the airflow sensor is located proximate to the outlet of the powered air purifying respirator.

11. A powered air purifying respirator comprising:
one or more valve assemblies, each of the one or more valve assemblies adapted to engage a filter;
wherein the one or more valve assemblies allow air to flow therethrough when the filter is engaged with the one or more valve assemblies; and
wherein the one or more valve assemblies prevent the air from flowing therethrough when the one or more valve assemblies are free of engagement with the filter.

12. The powered air purifying respirator according to claim 11, wherein the one or more valve assemblies comprise:
a valve support,
a valve cover coupled to the valve support,
and
a spring, the spring biasing the valve support in a first direction causing the valve cover to engage the one or more valve assemblies when the one or more valve assemblies are free of engagement with the filter.

13. The powered air purifying respirator according to claim 12, wherein engagement of the filter with the valve support causes the valve support to move in a second direction, compressing the spring, and causing the valve cover to release from engagement with the one or more valve assemblies.

14. The powered air purifying respirator according to claim 12, wherein the valve support includes one or more projections extending radially from the valve support and the one or more valve assemblies include one or more tracks extending radially into the one or more valve assemblies; and
wherein the one or more projections are slidably engaged with the one or more tracks.

15. The powered air purifying respirator according to claim 7, wherein one or more valve assemblies include three valve assemblies.

16. The powered air purifying respirator according to claim 15, wherein the powered air purifying respirator is capable of operating when one, two, or three of the three valve assemblies are each engaged with the filter.

17. A method for operating a powered air purifying respirator, the method comprising:
receiving, by the powered air purifying respirator, a first filter at a first time;
sensing, by an airflow sensor, an airflow;
directing, by a controller in communication with the airflow sensor, a blower speed based upon the airflow;
receiving, by the powered air purifying respirator, a second filter at a second time; and
repeating the sensing step and the directing step for the second filter;
wherein the first filter and the second filter are characterized by a different rating according to BS EN 14387:2004+A1:2008.

18. The method according to claim 17, wherein the airflow sensor is located proximate to an outlet of a fluid moving device of the powered air purifying respirator.

19. The method according to claim 18, wherein the airflow sensor is offset from a first central transverse axis of the outlet by a length and offset from a second transverse axis of the outlet by a length.

20. The method according to claim 17, wherein the sensing step and the directing step are performed in substantially real-time upon receiving the first filter, the second filter, or both.
